(19) United States
(12) Patent Application Publication
(10) Pub. No.: US 2008/0228944 A1
(43) Pub. Date: Sep. 18, 2008

(54) Method and Apparatus for Providing Network Address of a Gate Device of a Local Network

(76) Inventors: Kyung Ju Lee, Gyeonggi-do (KR); Yu Kyoung Song, Gyeonggi-do (KR)

Correspondence Address: LEE, HONG, DEGERMAN, KANG & SCHMADEKA, 660 S. FIGUEROA STREET, Suite 2300, LOS ANGELES, CA, 90017, US

(21) Appl. No.: 11/912,119

(22) PCT Filed: Apr. 19, 2006
(86) PCT No.: PCT/KR2006/001452

§ 371 Date: May 20, 2008

Related U.S. Application Data
(60) Provisional application No. 60/673,253, filed on Apr. 19, 2005.

(30) Foreign Application Priority Data
May 3, 2005 (KR) 10-2005-0037009

(51) Int. Cl. G06F 15/16

(52) U.S. Cl. 709/245

(57) ABSTRACT

The present invention relates to method and apparatus for providing IP address of a gateway (IGD) of a home network. A remote device has to know IP address of the gateway when it queries/controls a device on a local network such as home network remotely. In a method in accordance with the present invention, identification and network address or URL of an external server are set to an IGD by a user Afterwards, a network address allocated to the IGD is transmitted to the external server along with the set identification (character string, domain name of IGD, etc.) in order that the network address allocated to the IGD is made known to a remote device through the external server

### TECHNICAL FIELD

The present invention relates to method and apparatus for enabling remote query and control for a device on a local network such as a home network.

### BACKGROUND ART

As an increasing number of electronic appliances such as video or audio apparatuses or PCs have been used in a home and digital techniques have become dominant in video and audio signal processing, the need for communication between home electronic appliances or communication with other networks is also increasing. In addition, the demand for controlling home electronic appliances through a single mobile apparatus such as a PDA is also increasing.

To meet the demand, home networking technology has emerged for connecting home electronic appliances such as digital TVs or DVD players. The UPnP (Universal Plug and Play) is a key technology required for implementing the home network.

According to the UPnP specification, every home network requires a server which allocates addresses to elements or nodes connected to the home network. Additionally, the server can communicate with external wide-area or global networks (e.g., Internet) as a gateway. Such a server is called the IGD (Internet Gateway Device). The IGD may be a stand-alone device or embedded within another apparatus such as a PC or refrigerator.

The user of the home network may want to request remote query or control for a device on the home network. In this case, the user needs to access the home network through the Internet, which is feasible only when the IP address of the IGD is known to the user. On the other hand, it is common that Internet service providers (ISPs) assign dynamic IP addresses for efficient management of IP addresses. In this case, the IP address of the IGD is not fixed and therefore the user of the home network may not know the IP address of the IGD, in which case the user cannot request remote query or control for a device on his/her own home network.

### DISCLOSURE OF THE INVENTION

It is an object of the present invention to enable to obtain the network address assigned to a gateway device of a local network from a remote place and thereby allow remote query or control for a device on the local network.

In one method according to the invention, if identification information and a network address of an external server is set in an IGD by a user, the network address assigned to the IGD is transmitted along with the stored identification information to the external server so that the network address assigned to the IGD can be obtained at a remote site via the external server.

In another method according to the invention, if the network address of a server which manages a domain name in association with a network address is set in an IGD by a user, the network address assigned to the IGD is transmitted to the server based on the stored network address so that the IGD can be remotely accessed via the server by specifying the domain name assigned to the IGD.

In one embodiment of the invention, if the user stores login information (i.e., the user's ID and password), the identification information, and a password for other users in an external server at registration, the network address received in association with the identification information from the IGD is stored in association with the information registered by the user.

In one embodiment of the invention, the external server provides the network address stored in association with the user's login information or the identification information when there is a request for the network address.

In another embodiment of the invention, the network address is provided in an encrypted format.

In another embodiment of the invention, the network address assigned to the IGD is transmitted to the server along with identification information for uniquely identifying the IGD.

In one embodiment of the invention, the identification information is the domain name assigned to the IGD.

### BRIEF DESCRIPTION OF THE DRAWINGS

FIG. 1 illustrates an exemplary network in accordance with one embodiment of the present invention and the procedure for exchanging signals;

FIG. 2 illustrates the procedure for setting information required for remote access in the IGD according to the embodiment shown in FIG. 1;

FIG. 3 illustrates an exemplary network in accordance with another embodiment of the present invention and the procedure for exchanging signals;

FIG. 4 illustrates the procedure for setting information required for remote access in the IGD and the device to be accessed remotely according to the embodiment shown in FIG. 3; and

FIG. 5 illustrates an exemplary network in accordance with yet another embodiment of the present invention and the procedure for transmitting information for remote access.

### BEST MODE FOR CARRYING OUT THE INVENTION

In order that the invention may be fully understood, preferred embodiments thereof will now be described with reference to the accompanying drawings.

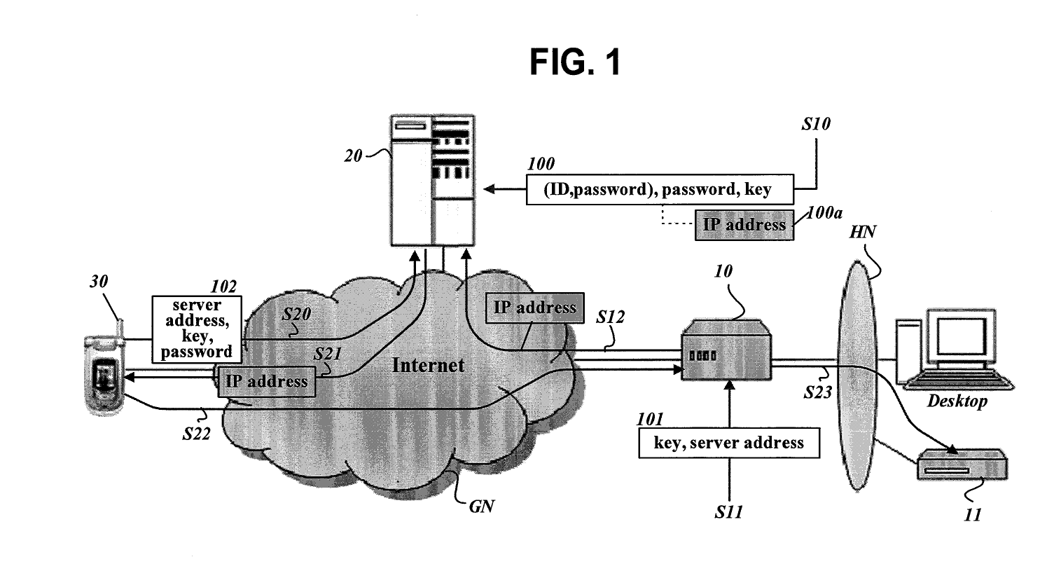

FIG. 1 shows a network in accordance with one embodiment of the present invention and the procedure for exchanging signals. The procedure shown in FIG. 1 will now be described in detail.

A user of a home network first registers at a server 20 for a service which enables the user to obtain the IP address of an IGD 10 from outside his/her own home network, by providing necessary information 100 for the server 20 (S10). The information 100 required at registration includes a login ID, a password, key information for identifying his/her own home network or the IGD thereof, and a password for other users to authenticate if a user can obtain the IP address assigned to the IGD. The key information for identifying the user's home network is unique information such as a character string including numbers, the telephone number of the registered user, or e-mail address of the registered user.

If the registration at the server 20 is completed, the user sets necessary information 101 in the IGD 10 (S11). The necessary information includes the fixed IP address or URL of the server 20 where the wide-area network address of the IGD 10 will be stored and the key information which was provided for the server 20 at user registration.

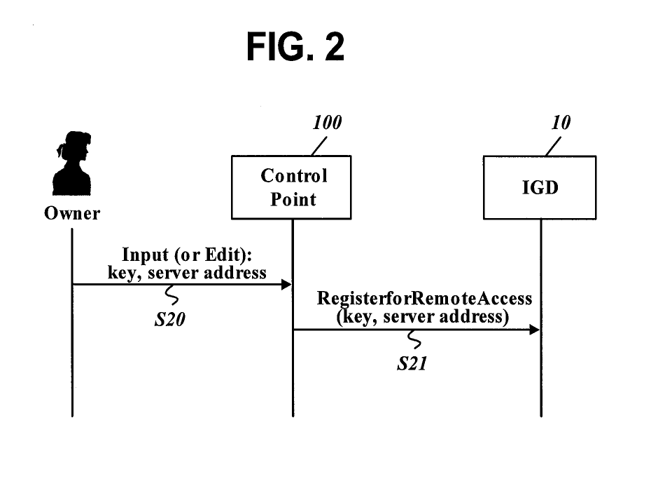

The information 101 may be stored in the IGD 10 through a control point, which is a control application for querying and/or controlling devices on the home network. FIG. 2 shows a procedure to set the information 101. As shown, if the user inputs or edits the necessary information (i.e., key information and server address) (S20), a control point l00 issues a registration action (RegisterforRemoteAccess( )} to the IGD 10 with the information as an input argument (S21). The IGD 10 responsive to the action stores the information necessary for remote access in an internal memory as described before.

If an IP address is assigned to the IGD 10 by an ISP after the necessary information 101 is stored, the IGD 10 transmits the assigned IP address along with the stored key information to the server 20 the IP address (or URL) of which was stored before (S12). Receiving the transmitted message, the server 20 searches its database for the registered user's entry based on the key information delivered by the message and stores the received IP address 100a in the user's entry.

The above operation of transmitting the IP address and key information is performed whenever the IP address of the IGD 10 is set initially or updated.

If the user needs to control a device on his/her home network using an Internet-accessible terminal 30, (e.g., if the user wants a recording operation of a recorder 11 on the home network) after the above steps are completed, the user first inputs necessary information 102 into the connection program running on the terminal 30. The user can access the service by inputting the known address or URL of the server 20 and logs in by inputting his/her own ID and password (S20). The server 20 identifies the user based on the information provided by the user.

If the user is identified, the server 20 transmits the IP address information stored in the user's entry in its own database (S21). The IP address may be encrypted by the user's password. After the user's login, the server 20 may request the user to provide the key information for finding the desired IP address. If requested, the user inputs the key information which he/she stored at registration of the service using the terminal 30. Receiving the key information, the server 20 searches its database for the IP address associated with the received key information and transmits the found IP address (S21).

Receiving the IP address transmitted by the server 20, the user inputs the received IP address into the program running on the terminal 30, (e.g., browser or VPN client) and makes a request for connection to the IGD 10 on his/her home network (S22). Connected to the home network through the browser, the user can issue a command for recording to the recorder 11 through a list of devices connected to the home network or a list of URLs (S23).

In the case where the user accesses the home network using a VPN client, the menu screen for selecting commands to be transmitted to the recorder 11 may not be provided through the IGD 10. In this case, the user may issue a desired command using the control point, which is the control application used on the home network, while connected to the IGD 10. Alternatively, the user may issue a desired command to a device using a user interface of a program dedicated for query and control for devices on the home network because the dedicated program runs if the connection to the IGD 100 is established.

If the received IP address is encrypted, the user invokes the VPN client on the terminal 30 and enters the encrypted IP address. The VPN client requests the user to provide the password. Receiving the password from the user, the VPN client decrypts the encrypted IP address using the password and accesses the IGD 10 having a VPN server on the home network. During the connection, the user goes through certification by the IGD 10 using a registered ID and password. If the certification is successful, the IGD 10 assigns one of local IP addresses available for the home network to the VPN client. Once an IP address is allocated to the VPN client, programs such as a general web browser, control point, etc can communicate with devices on the home network as if they were directly connected to the home network.

If the user does not have an Internet-accessible terminal, the user may ask a person (e.g., a family member) to query or control a particular device. In this case, the user informs the person of the password for other users which the user registered. The person then connects to the server 20 using his/her own terminal and enters the key information and password. The server 20 locates the registered user's entry in its database using the inputted key information. If it is determined that the registered password for other users match the inputted password, the server 20 transmits the IP address of the IGD stored in the user's entry. The procedure for accessing a particular device on the home network using the transmitted IP address is the same as that mentioned earlier.

Another embodiment of the invention uses a fixed domain name assigned to the IGD of a home network without obtaining the IP address thereof.

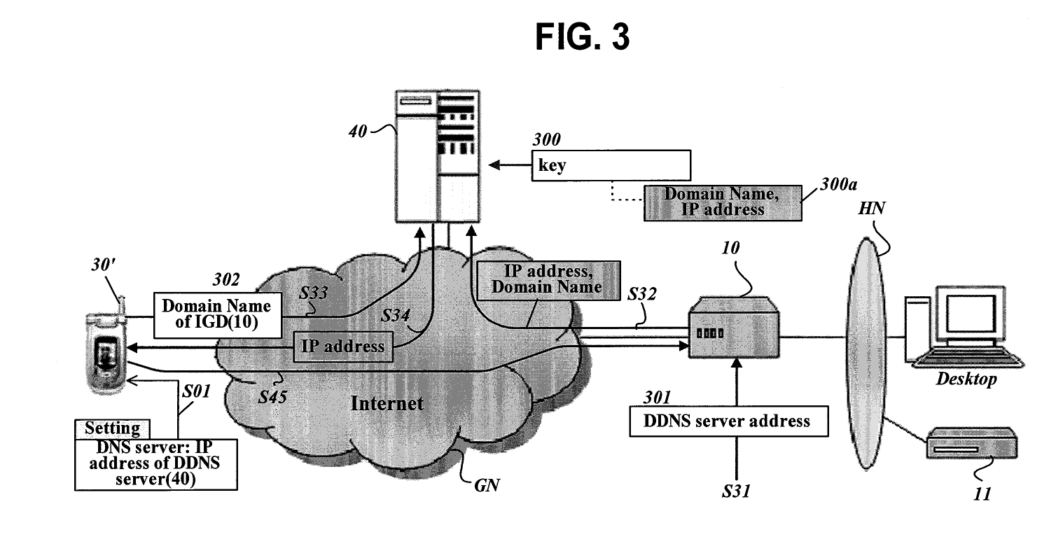

FIG. 3 shows an exemplary network in accordance with another embodiment of the invention and the procedure for exchanging signals. The user first stores the fixed IP address or URL 301 of a dynamic domain name system (DDNS) server 40 in the IGD 10 (S31).

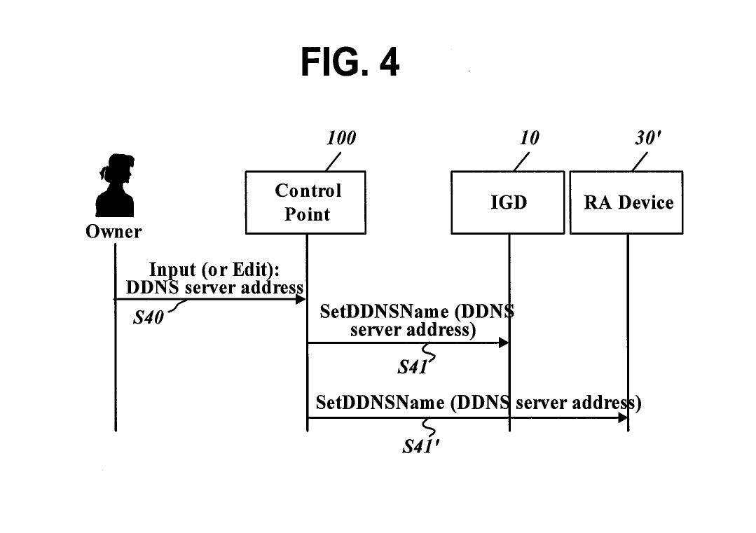

The information 301 may be stored in the IGD 10 through a control point, which is a control application for querying and/or controlling devices on the home network. FIG. 4 shows the procedure. As shown, if the user inputs or edits the necessary information (i.e., the DDNS server address) (S40), the control point 100 issues a registration action (SetDDNSName( )) to the IGD 10 with the information as an input argument (S41). The IGD 10 responsive to the action stores the information necessary for remote access in an internal memory as described before.

If an IP address is assigned to the IGD 10 by an ISP after the necessary information 301 is stored, the IGD 10 transmits the assigned IP address along with key information for the identification of the message sender to the DDNS server 40 the IP address (or URL) of which was stored before (S32). The key information may be the information which the user stored in the DDNS server 40 at registration or the domain name assigned to the IGD 10. Any type of information which provides uniqueness to a particular device can be used as the key information. Receiving the transmitted message, the DDNS server 40 searches its database for the registered user's entry based on the key information and stores the received IP address and the domain name 300a of the IGD 10 in the user's entry. The domain name 300a of the IGD 10 may be delivered to the DDNS server 40 by the message or may be provided to the DDNS server 40 by other means and be stored in association with the key information.

The above operation of transmitting the IP address of the IGD 10 (or the domain name thereof as well) is performed whenever the IP address of the IGD 10 is set initially or updated. As a result, the DDNS server 40 always has the latest IP address and fixed domain name of the IGD 10.

If the user needs to access his/her own home network from outside the home network through the Internet using an Internet-accessible terminal 30′ (e.g., a cellular phone), the user sets the DDNS server 40 as a DNS server of the Internet-accessible terminal 30′ in its network configuration (S01). The network configuration for the Internet-accessible terminal may be performed by an action via the control point 100 as shown in FIG. 4 (S41′).

When the user needs to query or control a device on the home network from outside the home network after the network configuration is completed, the user inputs the domain name 302 of the IGD 10 into a connection program (e.g., a general browser or VPN client) running on the terminal 30′ and requests connection. The request for connection with the domain name as an input argument is transmitted to the DDNS server 40 with reference to the preset DNS server information (S33). The DDNS server 40 searches its database for the received domain name to find the IP address stored in association with the domain name and returns the found IP address to the connection program (S34). The connection program then makes a request for remote connection with the received IP address as the destination and thus connects to the IGD 10 (S35). As a result, the terminal 30′ can access the home network without knowing the dynamic IP address of the IGD 10. The user can also access his/her home network only if he/she knows the fixed domain name of the IGD 10. Since the domain name can be set in the terminal 30′ or the application program running thereon, the user does not need to remember the domain name.

After the remote connection is established, the user can access any device on the home network in the same manner as described before.

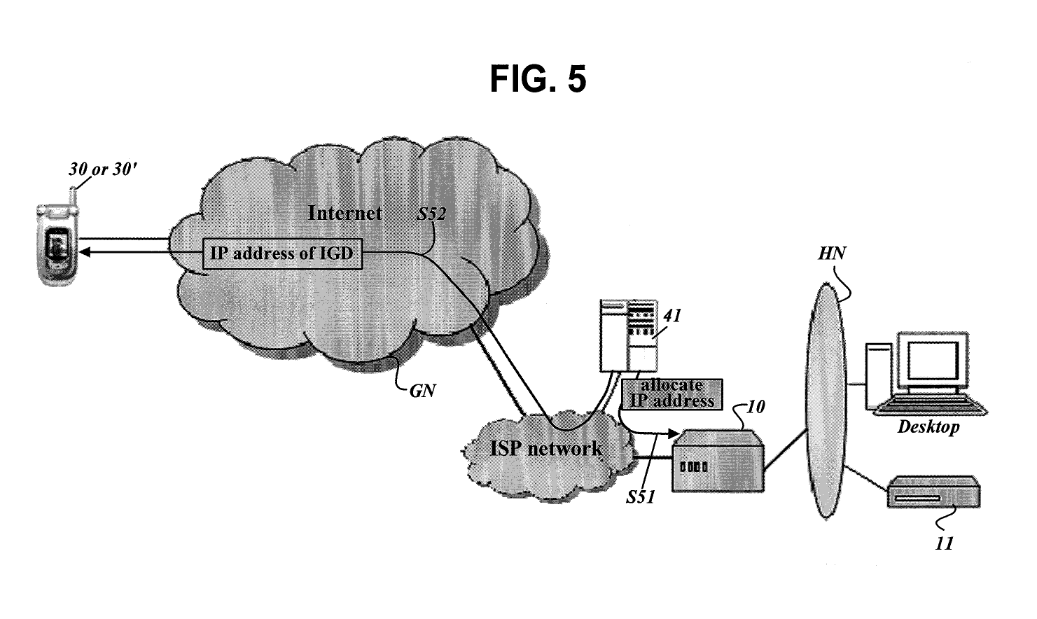

In yet another embodiment of the invention shown in FIG. 5, the ISP connected to the home network may manage a server 41 functioning as the aforementioned external server 20 or 40. In this embodiment, the ISP always knows the IP address of the IGD 10 because it is the ISP who assigns the IP address to the IGD 10. Since the server 41 of the ISP plays the same role as the external server 20 or 40 of the previous embodiments, the server 41 can inform a remote device 30 or 30′ of the IP address of the IGD 10 (S52). In this case, the IGD 10 does not need to know the IP address of the server 41 and it is sufficient that the IP address of the server 41 is set in the remote device.

The present invention described with reference to the preferred embodiments enables remote query or control for any device on a home network only if the user of the home network has Internet connection, thereby significantly improving the convenience of the home network.

While the invention has been disclosed with respect to a limited number of embodiments, those skilled in the art, having the benefit of this disclosure, will appreciate numerous modifications and variations therefrom. It is intended that all such modifications and variations fall within the spirit and scope of the invention.

1. A method for providing a network address assigned to a device for a user, comprising the steps of:
(a) storing identification information and a network address of an external server; and
(b) transmitting the network address assigned to the device along with the stored identification information to the external server.

2. The method of claim 1, wherein the identification information is identical to identification information registered at the external server by a user of the device.

3. The method of claim 2, wherein the identification information consists of characters and/or numbers and any identification information registered at the external server is not identical to other identification information registered at the external server.

4. The method of claim 1, wherein step (b) is performed whenever the network address of the device is set initially or updated.

5. The method of claim 1, further comprising the step of:
(c) storing the received identification information and network address and transmitting the stored network address to a terminal connected to the external server if identification information received from the terminal is identical to the stored identification information, the storing and the transmitting being conducted by the external server.

6. The method of claim 1, wherein the identification information and the network address of the external server at step (a) is provided by a user.

7. A method for providing a network address assigned to a device for a user, comprising the steps of:
(a) storing a network address of an external sever which manages a domain name in association with a network address; and
(b) transmitting the network address assigned to the device to the external server based on the stored network address.

8. The method of claim 7, wherein step (b) transmits the network address assigned to the device along with identification information for uniquely identifying the device.

9. The method of claim 8, wherein the identification information is a domain name assigned to the device.

10. The method of claim 7, wherein step (b) is performed whenever the network address of the device is set initially or updated.

11. A networked apparatus, comprising:
a device having a network address for enabling mutual access between a local network and a wide area network; and
a server connected to the wide area network for storing identification information and the network address transmitted by the device and for providing the network address through the wide area network if there is a request for the network address,
wherein the device transmits preset identification information along with the network address to the server whenever the network address of the device is assigned initially or updated.

12. The apparatus of claim 11, wherein the server locates a database entry based on the received identification information and stores the received network address in the entry.

13. The apparatus of claim 12, wherein the database entry includes fields of a user ID, a password, identification information, a password for other users, and a network address.

14. The apparatus of claim 13, wherein information provided by a user at user registration is stored in the fields of a user ID, a password, and a password for other users.

15. The apparatus of claim 13, wherein the server provides a network address associated with identification information received by a connection certified by the user's password or the password for other users.

16. The apparatus of claim 13, wherein the identification information comprises characters and/or numbers and any identification information stored in a database entry is not identical to identification information stored in other database entries.

17. A networked apparatus, comprising:
a device having a network address for enabling mutual access between a local network and a wide area network; and
a server connected to the wide area network for storing the domain name of the device in association with the network address transmitted from the device and for converting the domain name into the network address associated with the domain name,
wherein the device transmits the network address to the server whenever the network address of the device is assigned initially or updated.

18. The apparatus of claim 17, wherein the device transmits the assigned network address along with identification information for uniquely identifying the device.

19. The apparatus of claim 18, wherein the identification information is the domain name assigned to the device.

20. The apparatus of claim 17, wherein the identification information is a unique character string which has been registered at the server by a user of the device.
